(19) United States
(12) Patent Application Publication
(10) Pub. No.: US 2024/0049002 A1
(43) Pub. Date: Feb. 8, 2024

(54) MULTIPLE SEQUENCES OF NETWORK OPERATIONS FOR MULTIPLE TRANSMISSION AND RECEPTION POINTS

(71) Applicant: QUALCOMM Incorporated, San Diego, CA (US)

(72) Inventors: Ahmed Attia Abotabl, San Diego, CA (US); Hung Dinh Ly, San Diego, CA (US); Yu Zhang, San Diego, CA (US); Marwen Zorgui, San Diego, CA (US)

(21) Appl. No.: 17/881,444

(22) Filed: Aug. 4, 2022

(51) Int. Cl. H04W 24/02; H04W 72/04; H04L 5/00; H04W 52/02

(52) U.S. Cl. CPC H04W 24/02; H04W 72/042; H04L 5/001; H04W 52/0203

(57) ABSTRACT

Methods, systems, and devices for wireless communications are described. The described techniques are directed to transmission and reception point (TRP)-specific network operation sequences. A first TRP may be configured with a first network operation sequence, and a second TRP may be configured with a second network operation sequence. The use of separate network operation sequences for different TRPs may enable some TRPs to operate in lower-power consumption modes, while simultaneously enabling a network to accommodate dynamic network traffic. Different network operation sequences may be configured with different parameters or restrictions. Different TRPs may be associated with different control resource set (CORESET) indices or different virtual component carriers. In some examples, a first TRP may indicate parameters to a UE for communicating with a second TRP in a flexible mode at the second TRP.

### FIELD OF TECHNOLOGY

The following relates to wireless communications, including multiple sequences of network operations for multiple transmission and reception points.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). Network entities, such as base stations, may consume large amounts of power, especially in 5G wireless communications systems. As such, it may be appropriate to reduce network power consumption, while still managing traffic loads within the network.

### SUMMARY

The described techniques relate to improved methods, systems, devices, and apparatuses that support multiple sequences of network operations for multiple transmission and reception points (TRPs). A first TRP may be configured with a first network operation sequence, and a second TRP may be configured with a second network operation sequence. The use of separate network operation sequences for different TRPs may enable some TRPs to operate in lower-power consumption modes, while simultaneously enabling a network to accommodate dynamic network traffic. Different network operation sequences may be configured with different parameters or restrictions. Different TRPs may be associated with different control resource set (CORESET) indices or different virtual component carriers. In some examples, a first TRP may indicate parameters to a UE for communicating with a second TRP in a flexible mode at the second TRP.

A method for wireless communication at a user equipment (UE) is described. The method may include receiving first control signaling indicating a first network operation sequence associated with a first network entity, the first network operation sequence including a first set of time intervals corresponding to a first set of network operation modes for the first network entity, receiving second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively, communicating with the first network entity in accordance with the first network operation sequence, and communicating with the second network entity in accordance with the second network operation sequence.

An apparatus for wireless communication at a UE is described. The apparatus may include a processor, memory coupled with the processor, and instructions stored in the memory. The instructions may be executable by the processor to cause the apparatus to receive first control signaling indicating a first network operation sequence associated with a first network entity, the first network operation sequence including a first set of time intervals corresponding to a first set of network operation modes for the first network entity, receive second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively, communicate with the first network entity in accordance with the first network operation sequence, and communicate with the second network entity in accordance with the second network operation sequence.

Another apparatus for wireless communication at a UE is described. The apparatus may include means for receiving first control signaling indicating a first network operation sequence associated with a first network entity, the first network operation sequence including a first set of time intervals corresponding to a first set of network operation modes for the first network entity, means for receiving second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively, means for communicating with the first network entity in accordance with the first network operation sequence, and means for communicating with the second network entity in accordance with the second network operation sequence.

A non-transitory computer-readable medium storing code for wireless communication at a UE is described. The code may include instructions executable by a processor to receive first control signaling indicating a first network operation sequence associated with a first network entity, the first network operation sequence including a first set of time intervals corresponding to a first set of network operation modes for the first network entity, receive second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively, communicate with the first network entity in accordance with the first network operation sequence, and communicate with the second network entity in accordance with the second network operation sequence.

In some examples of the method, apparatuses, and non-transitory computer-readable medium described herein, communicating with the first network entity may include operations, features, means, or instructions for communicating with the first network entity in accordance with the first network operation sequence and based on control information associated with the first control resource set index.

In some examples of the method, apparatuses, and non-transitory computer-readable medium described herein, communicating with the first network entity based on control information associated with the first control resource set index may include operations, features, means, or instructions for receiving, during one or more active modes of the first set of network operation modes, control information associated with the first control resource set index.

In some examples of the method, apparatuses, and non-transitory computer-readable medium described herein, communicating with the first network entity based on control information associated with the first control resource set index may include operations, features, means, or instructions for avoiding receiving, during one or more inactive modes of the first set of network operation modes, control information associated with the first control resource set index.

In some examples of the method, apparatuses, and non-transitory computer-readable medium described herein, communicating with the first network entity may include operations, features, means, or instructions for communicating with the first network entity on the first set of virtual component carriers in accordance with the first network operation sequence.

Some examples of the method, apparatuses, and non-transitory computer-readable medium described herein may further include operations, features, means, or instructions for receiving, from the first network entity, downlink control information including one or more parameters for communicating with the second network entity during a first time interval, the first time interval corresponding to a flexible mode of the second set of network operation modes for the second network entity.

In some examples of the method, apparatuses, and non-transitory computer-readable medium described herein, receiving the downlink control information may include operations, features, means, or instructions for receiving the downlink control information in a second time interval corresponding to an active mode of the first set of network operation modes for the first network entity, the second time interval overlapping with a third time interval corresponding to an inactive mode of the second set of network operation modes for the second network entity.

In some examples of the method, apparatuses, and non-transitory computer-readable medium described herein, the downlink control information indicates a second control resource set index or a second set of virtual component carriers associated with the second network entity.

In some examples of the method, apparatuses, and non-transitory computer-readable medium described herein, the downlink control information includes multiple sets of parameters for communicating with multiple network entities during time intervals corresponding to flexible modes, the multiple sets of parameters including the one or more parameters for communicating with the second network entity during the first time interval.

In some examples of the method, apparatuses, and non-transitory computer-readable medium described herein, the first network operation sequence may be associated with a first set of parameters, the second network operation sequence may be associated with a second set of parameters different from the first set of parameters, and the first set of parameters, the second set of parameters, or both, include a network energy consumption level, a maximum data rate, or both.

In some examples of the method, apparatuses, and non-transitory computer-readable medium described herein, the first control signaling may be the same as the second control signaling.

In some examples of the method, apparatuses, and non-transitory computer-readable medium described herein, the first set of network operation modes, the second set of network operation modes, or both, include a first network energy saving mode, a second network energy saving mode, a flexible mode, a legacy mode, an inactive mode, or any combination thereof.

A method for wireless communication at a first network entity is described. The method may include transmitting, to a UE, first control signaling indicating a first network operation sequence associated with the first network entity, the first network operation sequence including a first set of time intervals corresponding to a first set of network operation modes for the first network entity, transmitting, to the UE, second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively, and communicating with the UE in accordance with the first network operation sequence.

An apparatus for wireless communication at a first network entity is described. The apparatus may include a processor, memory coupled with the processor, and instructions stored in the memory. The instructions may be executable by the processor to cause the apparatus to transmit, to a UE, first control signaling indicating a first network operation sequence associated with the first network entity, the first network operation sequence including a first set of time intervals corresponding to a first set of network operation modes for the first network entity, transmit, to the UE, second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively, and communicate with the UE in accordance with the first network operation sequence.

Another apparatus for wireless communication at a first network entity is described. The apparatus may include means for transmitting, to a UE, first control signaling indicating a first network operation sequence associated with the first network entity, the first network operation sequence including a first set of time intervals corresponding to a first set of network operation modes for the first network entity, means for transmitting, to the UE, second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively, and means for communicating with the UE in accordance with the first network operation sequence.

A non-transitory computer-readable medium storing code for wireless communication at a first network entity is described. The code may include instructions executable by a processor to transmit, to a UE, first control signaling indicating a first network operation sequence associated with the first network entity, the first network operation sequence including a first set of time intervals corresponding to a first set of network operation modes for the first network entity, transmit, to the UE, second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively, and communicate with the UE in accordance with the first network operation sequence.

In some examples of the method, apparatuses, and non-transitory computer-readable medium described herein, communicating with the UE may include operations, features, means, or instructions for communicating with the UE in accordance with the first network operation sequence and based on control information associated with the first control resource set index.

In some examples of the method, apparatuses, and non-transitory computer-readable medium described herein, communicating with the UE based on control information associated with the first control resource set index may include operations, features, means, or instructions for transmitting, during one or more active modes of the first set of network operation modes, control information associated with the first control resource set index.

In some examples of the method, apparatuses, and non-transitory computer-readable medium described herein, communicating with the UE based on control information associated with the first control resource set index may include operations, features, means, or instructions for avoiding transmitting, during one or more inactive modes of the first set of network operation modes, control information associated with the first control resource set index.

In some examples of the method, apparatuses, and non-transitory computer-readable medium described herein, communicating with the UE may include operations, features, means, or instructions for communicating with the UE on the first set of virtual component carriers in accordance with the first network operation sequence.

Some examples of the method, apparatuses, and non-transitory computer-readable medium described herein may further include operations, features, means, or instructions for transmitting, to the UE, downlink control information including one or more parameters for communicating with the second network entity during a first time interval, the first time interval corresponding to a flexible mode of the second set of network operation modes for the second network entity.

In some examples of the method, apparatuses, and non-transitory computer-readable medium described herein, transmitting the downlink control information may include operations, features, means, or instructions for transmitting the downlink control information in a second time interval corresponding to an active mode of the first set of network operation modes for the first network entity, the second time interval overlapping with a third time interval corresponding to an inactive mode of the second set of network operation modes for the second network entity.

In some examples of the method, apparatuses, and non-transitory computer-readable medium described herein, the downlink control information indicates a second control resource set index or a second set of virtual component carriers associated with the second network entity.

In some examples of the method, apparatuses, and non-transitory computer-readable medium described herein, the downlink control information includes multiple sets of parameters for communicating with multiple network entities during time intervals corresponding to flexible modes, the multiple sets of parameters including the one or more parameters for communicating with the second network entity during the first time interval.

In some examples of the method, apparatuses, and non-transitory computer-readable medium described herein, the first network operation sequence may be associated with a first set of parameters, the second network operation sequence may be associated with a second set of parameters different from the first set of parameters, and the first set of parameters, the second set of parameters, or both, include a network energy consumption level, a maximum data rate, or both.

In some examples of the method, apparatuses, and non-transitory computer-readable medium described herein, the first control signaling may be the same as the second control signaling.

In some examples of the method, apparatuses, and non-transitory computer-readable medium described herein, the first set of network operation modes, the second set of network operation modes, or both, include a first network energy saving mode, a second network energy saving mode, a flexible mode, a legacy mode, an inactive mode, or any combination thereof.

### BRIEF DESCRIPTION OF THE DRAWINGS

FIG. 1 illustrates an example of a wireless communications system that supports multiple sequences of network operations for multiple transmission and reception points (TRPs) in accordance with one or more aspects of the present disclosure.

FIG. 2 illustrates an example of a wireless communications system that supports multiple sequences of network operations for multiple TRPs in accordance with one or more aspects of the present disclosure.

FIG. 3 illustrates an example of a flexible state indication for a flexible mode in accordance with one or more aspects of the present disclosure.

FIG. 4 illustrates an example of a process flow that supports multiple sequences of network operations for multiple TRPs in accordance with one or more aspects of the present disclosure.

FIGS. 5 and 6 show block diagrams of devices that support multiple sequences of network operations for multiple TRPs in accordance with one or more aspects of the present disclosure.

FIG. 7 shows a block diagram of a communications manager that supports multiple sequences of network operations for multiple TRPs in accordance with one or more aspects of the present disclosure.

FIG. 8 shows a diagram of a system including a device that supports multiple sequences of network operations for multiple TRPs in accordance with one or more aspects of the present disclosure.

FIGS. 9 and 10 show block diagrams of devices that support multiple sequences of network operations for multiple TRPs in accordance with one or more aspects of the present disclosure.

FIG. 11 shows a block diagram of a communications manager that supports multiple sequences of network operations for multiple TRPs in accordance with one or more aspects of the present disclosure.

FIG. 12 shows a diagram of a system including a device that supports multiple sequences of network operations for multiple TRPs in accordance with one or more aspects of the present disclosure.

FIGS. 13 and 14 show flowcharts illustrating methods that support multiple sequences of network operations for multiple TRPs in accordance with one or more aspects of the present disclosure.

### DETAILED DESCRIPTION

In some wireless communications systems (e.g., Fifth Generation (5G) wireless communications systems), network entities (e.g., base stations) may consume large amounts of power. As such, it may be appropriate to reduce network power consumption, while still managing traffic loads within a network. One technique that has been proposed is the use of network operation sequences that include different network operational modes. For example, a network entity operating in accordance with a network operation sequence may transition through various operation modes that provide varying levels of energy savings and data rates. Such network operation sequences may enable network entities to more effectively balance traffic needs with reduced power consumption. However, network operation sequences implemented in a network may offer limited flexibility and may not enable the network to adequately handle traffic loads while simultaneously providing power savings.

The described techniques are directed to transmission and reception point (TRP)-specific network operation sequences. A first TRP may be configured with a first network operation sequence, and a second TRP may be configured with a second network operation sequence. The use of separate network operation sequences for different TRPs may enable some TRPs to operate in lower-power consumption modes, while simultaneously enabling a network to accommodate dynamic network traffic. Different network operation sequences may be configured with different parameters or restrictions. Different TRPs may be associated with different control resource set (CORESET) indices or different virtual component carriers. In some examples, a first TRP may indicate parameters to a UE for communicating with a second TRP in a flexible mode at the second TRP.

Aspects of the disclosure are initially described in the context of wireless communications systems. Aspects of the disclosure are further illustrated by and described with reference to apparatus diagrams, system diagrams, and flowcharts that relate to multiple sequences of network operations for multiple transmission and reception points.

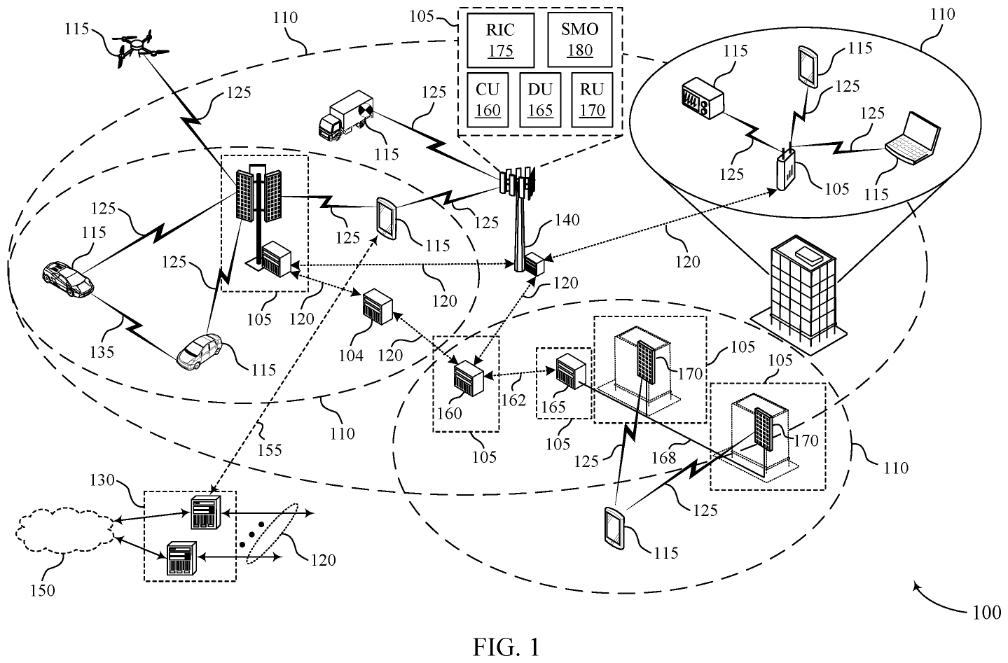

FIG. 1 illustrates an example of a wireless communications system 100 that supports multiple sequences of network operations for multiple transmission and reception points in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support multiple sequences of network operations for multiple transmission and reception points as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, the wireless communications system 100 may support TRP-specific network operation sequences. As noted previously herein, the term “network operation sequence” may be used to refer to a series or sequence of different network operation modes which enables network entities 105 to transition through the various operation modes that provide varying levels of energy savings and data rates.

Aspects of the present disclosure may enable a network entity 105 (e.g., a base station) to configure multiple network operation sequences on a TRP-by-TRP basis. For example, a first TRP may be configured with a first network operation sequence, and a second TRP may be configured with a second network operation sequence that is separate and independent from the first network operation sequence. In some aspects, network operation sequences may be signaled to UEs 115 (and other wireless devices) so that the UEs 115 can communicate with each TRP in accordance with a respective network operation sequence configured for the TRP. The use of separate network operation sequences for different TRPs may enable some TRPs to operate in lower-power consumption modes, while simultaneously enabling a network to accommodate dynamic network traffic. Different network operation sequences may be configured with different parameters or restrictions. Different TRPs may be associated with different CORESET indices or different virtual component carriers. In some examples, a first TRP may indicate parameters to a UE for communicating with a second TRP in a flexible mode at the second TRP.

Techniques described herein may enable a network to implement network operation sequences on a TRP-by-TRP basis. As such, techniques described herein may enable a network to implement network operation sequences with a finer granularity as compared to some conventional techniques and may thereby enable a network to more efficiently and effectively support network traffic with minimal power consumption. In particular, techniques described herein may be used to ensure that some minimum quantity of TRPs are able to support high data rates, while remaining TRPs may operate in accordance with low power-consumption network operation sequences. As such, techniques described herein may enable a network to ensure that network traffic may be accommodated, while lowering the overall power consumption of the network.

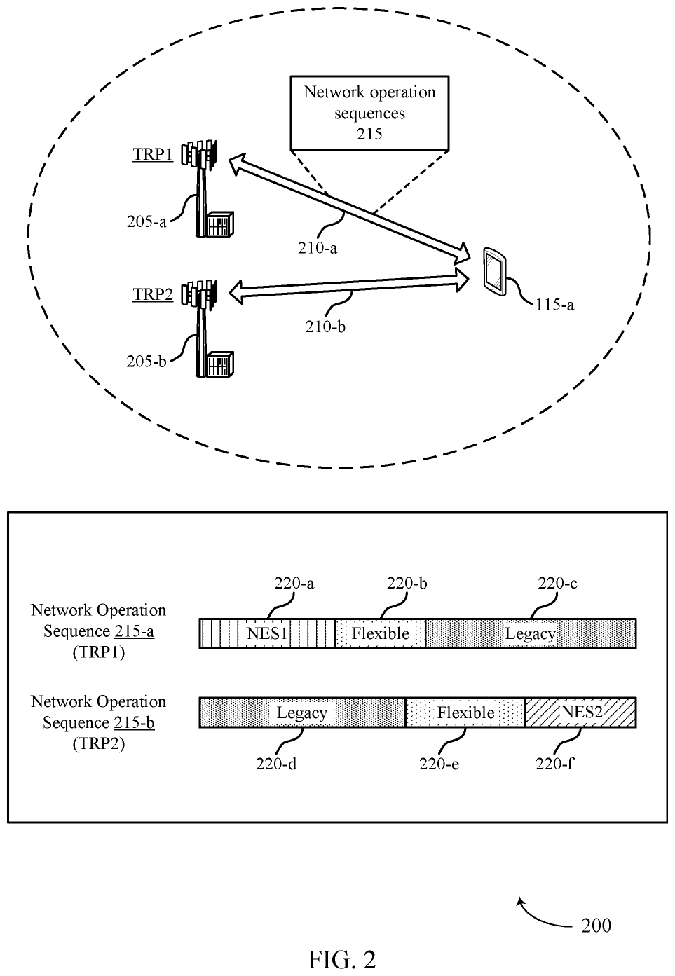

FIG. 2 illustrates an example of a wireless communications system 200 that supports multiple sequences of network operations for multiple transmission and reception points in accordance with one or more aspects of the present disclosure. In some examples, aspects of the wireless communications system 200 may implement, or be implemented by, aspects of the wireless communications system 100. In particular, the wireless communications system 200 may support signaling, configurations, and other mechanisms which enable passive devices to determine a relative priority of read and write operations that are to be performed at the respective passive devices, as described with respect to FIG. 1.

The wireless communications system 200 includes a first TRP 205-a, a second TRP 205-b, and a UE 115-a. The first TRP 205-a may be an example of a first network entity 105, and the second TRP 205-b may be an example of a second network entity 105. A TRP may refer to one or more antenna arrays available to a network entity 105 for transmission or reception. In some examples, a TRP may be located at a specific geographic location. Each TRP communicating with the UE 115-a may be associated with a different CORESET. The UE 115-a may communicate with the first TRP 205-a using a communication link 210-a, which may be an example of an NR or LTE link between the UE 115-a and the first TRP 205-a. Similarly, the UE 115-a may communicate with the second TRP 205-b using a communication link 210-b, which may be an example of an NR or LTE link between the UE 115-a and the second TRP 205-b. In some cases, the communication link 210-a or the communication link 210-b may be an example of an access link (e.g., Uu link) which may include a bi-directional link that enables both uplink and downlink communication.

For example, the UE 115-a may transmit uplink signals, such as uplink control signals or uplink data signals, to one or more components of the first TRP 205-a using the communication link 210-a, and one or more components of the first TRP 205-a may transmit downlink signals, such as downlink control signals or downlink data signals, to the UE 115-a using the communication link 210-a. Similarly, the UE 115-a may transmit uplink signals, such as uplink control signals or uplink data signals, to one or more components of the second TRP 205-b using the communication link 210-b, and one or more components of the second TRP 205-b may transmit downlink signals, such as downlink control signals or downlink data signals, to the UE 115-a using the communication link 210-b.

As noted previously herein, network entities 105 (e.g., base stations) consume large amounts of power. Network energy consumption accounts for approximately 23% of the total expense associated with operating a cellular network. Most energy consumption within a cellular network is associated with a RAN. For example, approximately 50% of 5G network energy consumption comes from the RAN. As such, it may be appropriate to reduce network power consumption, while still managing traffic loads within the network. For instance, network energy saving features may be appropriate for the adoption and expansion of cellular networks.

The energy consumption of network entities 105 may be based on a number of factors, including power amplifier (PA) efficiency, a quantity of transmit or receive antennas operated (e.g., a transmit radio distribution unit (TxRU) interface), traffic load, sleep states and associated transition times for transitioning into and out of the sleep states, and one or more reference parameters or configurations. Techniques used to reduce network energy consumption may be evaluated on a number of different key performance indicators (KPIs) related to network and UE 115 performance, including spectral efficiency, capacity, user perceived throughput (UPT), latency, handover performance, call drop rate, initial access performance, service-level agreement (SLA) assurance-related parameters, energy efficiency, UE 115 power consumption, and complexity.

One technique that has been proposed to reduce network power consumption is the concept of network sleep modes. In particular, network entities 105 may enter different “sleep modes” based on network traffic. Sleep modes may include, but are not limited to, light sleep modes, “legacy” operation modes, deep sleep modes, and the like. Different sleep modes may have different power consumption levels and different transition times for the network entity 105 to transition into and out of the respective sleep modes. Moreover, sleep modes may be operated differently in accordance with a number of parameters. For example, some sleep modes may cause a network entity 105 to turn off radio frequency chains to reduce power consumption, while other sleep modes may maintain some level of radio frequency chain operation.

Building on the concept of network sleep modes, some wireless communications systems may enable the use of “network operation sequences” that include a series or sequence of different network operation modes (e.g., a sequence or series of different sleep modes). For example, a network entity 105 operating in accordance with a network operation sequence may transition through various network operation modes (e.g., various sleep modes) that provide varying levels of energy savings, support different data rates or data latencies, etc. Network operation sequences may cause a network entity 105 to transition through a series or sequence of different operation modes (or sleep modes) according to some periodicity. Such network operation sequences may enable network entities 105 to more effectively balance traffic demands with minimal power consumption. As such, network operation modes may provide a semi-static approach to reduce network power consumption.

Network operation modes that may be implemented in accordance with network operation sequences may include any operation mode or sleep mode, including a first network energy saving (NES) mode (e.g., NES1), a second network energy savings mode (e.g., NES2), a flexible mode (e.g., a mode that enables a network to dynamically adapt to different operation modes or a mode dynamically indicated by a network depending on current traffic conditions), a legacy operation mode (e.g., normal or “full-capacity” network operation), and the like. Network operation modes that support at least some communications with a UE 115 may be categorized as active modes, and network operation modes that support no communications or prevent communications with a UE 115 may be categorized as inactive modes. For the purposes of the present disclosure, the term “network operation mode” may refer to a specific operation by a network entity 105 that is intended to facilitate network traffic or reduce network energy consumption. As such, different network operation modes may be associated with different parameters, including power consumption, latency, data rates, throughput, and the like. Network entities 105 may apply different energy savings techniques for respective network operation modes. For example, different operation modes may reduce network energy consumption by reducing a quantity of operational antenna ports, reducing transmit power, and the like. In this regard, the term “network operation mode” may include or encompass network sleep modes.

Some wireless communications systems may implement network operation sequences in a network. For instance, the network may apply different network energy saving techniques such as reduction in a number of antenna ports, a reduction in a transmit power, or other techniques. Turning on or off TRPs may be one way to reduce energy consumption in a network. In some examples, introducing a cell-specific sequence of network operations may allow a network to operate in different energy saving states and preserve a flexible time interval with a configuration that may be adapted by a network based on traffic conditions. The techniques described herein may further enhance a usage of network operation sequences to more efficiently and effectively support network traffic with minimal power consumption. With multiple TRPs, each TRP may be configured to operate in accordance with a network operation sequence (e.g., a given sequence of operations). For instance, when a first TRP is operating in a low transmit power or reduced antenna configuration, a second TRP may increase a transmit power or a number of antennas to overcome a degradation from the first TRP.

Accordingly, aspects of the present disclosure are directed to TRP-specific network operation sequences that may be implemented by network entities 105. In particular, aspects of the present disclosure may enable a network entity 105 (e.g., a base station) to configure multiple network operation sequences on a TRP-by-TRP basis. In this regard, aspects of the present disclosure may enable TRP-specific network operation sequences that enable TRPs to be dynamically switched on or off (or switched between operation modes) in order to save network energy depending on a network load (e.g., switch off TRPs or switch TRPs to power saving operation modes when a network load may be supported by fewer TRPs or TRPs operating in power saving operation modes).

The wireless communications system 200 described herein may support TRP-specific network operation sequences that may be semi-statically or dynamically configured or modified. Using these techniques, a network may manage operation and traffic loads in a flexible manner and may accommodate operation of both legacy, advanced, and future UEs 115. Extending network operation sequences across TRPs may enable a network to operate according to different network operation modes across TRPs and save energy depending on a network load.

In some aspects, the first TRP 205-a or another network entity 105 may transmit control signaling to the UE 115-a indicating network operation sequences 215 associated with different TRPs. In other aspects, each TRP in communication with the UE 115-a may transmit control signaling to the UE 115-a indicating a network operation sequence associated with the TRP. The control signaling may be RRC signaling, DCI signaling, MAC-CE signaling, or any combination thereof. In some cases, the UE 115-a may be configured with a table or other data object that includes potential or candidate network operation sequences, and the control signaling may utilize one or more bit field values or indices to indicate which network operation sequences 215 from the table or data object correspond to which TRP 205. The control signaling indicating the network operation sequences 215 may include a first network operation sequence 215-a associated with the first TRP 205-a and a second network operation sequence 215-b associated with a second TRP 205-b. The UE 115-a may therefore be configured to communicate with the first TRP 205-a in accordance with the first network operation sequence 215-a, and the UE 115-a may be configured to communicate with the second TRP 205-b in accordance with the second network operation sequence 215-b.

In some examples, control signaling used to indicate the first network operation sequence 215-a for the first TRP 205-a may indicate a CORESET index or a CORESET pool index associated with the first TRP 205-a. During an active mode of the first network operation sequence 215-a, the UE 115-a may monitor for control messages in control channels associated with the CORESET index or the CORESET pool index (e.g., control channels in a CORESET having the CORESET index or the CORESET pool index), and the UE 115-a may communicate with the first TRP 205-a in accordance with the control messages. During an inactive mode of the first network operation sequence 215-a, the UE 115-a may avoid monitoring for control messages in control channels associated with the CORESET index or the CORESET pool index (e.g., control channels in a CORESET having the CORESET index or the CORESET pool index), and the UE 115-a may avoid communicating with the first TRP 205-a.

In some examples, control signaling used to indicate the first network operation sequence 215-a for the first TRP 205-a may indicate a set of virtual component carriers associated with the first TRP 205-a (e.g., the virtual component carriers may correspond to component carriers used by the first TRP 205-a). That is, instead of tying a sequence of network operations with a TRP 205 through a CORESET index or a CORESET pool index, the UE 115-a may be configured with multiple sets of virtual component carriers representing multiple TRPs 205. The framework of a sequence of network operations across virtual component carriers may then be reused for multiple TRPs. During an active mode of the first network operation sequence 215-a, the UE 115-a may communicate with the first TRP 205-a on the set of virtual component carriers. During an inactive mode of the first network operation sequence 215-a, the UE 115-a may avoid communicating with the first TRP 205-a on the set of virtual component carriers.

In some implementations, a single TRP 205 may be associated with one or more network operation sequences 215. For instance, the first TRP 205-a may be associated with the first network operation sequence 215-a and another network operation sequence, or the second TRP 205-b may be associated with the second network operation sequence 215-b and another network operation sequence. In such implementations, the first TRP 205-a or another network entity 105 may be configured to dynamically update or switch network operation sequences 215 for each TRP via control signaling (e.g., RRC signaling, a MAC-CE, or a DCI message).

Moreover, in cases where a single TRP 205 is associated with multiple candidate or potential network operation sequences 215, the UE 115-a, the first TRP 205-a, the second TRP 205-b, a network entity 105, or some combination thereof may be configured to select one of the candidate network operation sequences 215 for the single TRP. Selection of a candidate network operation sequence 215 for a TRP 205 may be performed based on explicit signaling from the first TRP 205-a or a network entity 105, based on network conditions, based on traffic to be communicated by the UE 115-a, the first TRP 205-a, or the network entity 105, in accordance with a network operation sequence configuration, or any combination thereof.

The use of separate network operation sequences 215 for different TRPs 205 may enable some TRPs 205 to operate in lower power consumption modes, while simultaneously accommodating network traffic. In other words, techniques described herein may enable different network operation sequences 215 and different network operation modes 220 to be implemented across TRPs 205. For example, the first TRP 205-a may have different functions and configurations (e.g., a different network operation sequence 215) as compared to the second TRP 205-b. By enabling different TRPs 205 to be configured with different network operation sequences 215, different network energy states or network energy consumption levels may be achieved at different TRPs 205. Moreover, enabling different TRPs 205 to be configured with different network operation sequences 215 may enable different needs and network loads to be managed across different TRPs 205.

As noted previously herein, each of the network operation sequences 215 may include one or more network operation modes 220. For instance, the first network operation sequence 215-a may include a first network operation mode 220-a (e.g., a NES1 mode), a second network operation mode 220-b (e.g., a flexible mode), and a third network operation mode 220-c (e.g., a NES2 mode). The second network operation sequence 215-b may include a first network operation mode 220-d (e.g., a legacy mode), a second network operation mode 220-e (e.g., a flexible mode), and a third network operation mode 220-f (e.g., a NES2 mode).

In this regard, the first TRP 205-a (and the UE 115-a) may be configured in accordance with each of the network operation modes 220 during a respective time interval of the first network operation sequence 215-a (e.g., communicate in accordance with the first network operation mode 220-a, the second network operation mode 220-b, and the third network operation mode 220-c during first, second, and third time intervals, respectively). Similarly, the second TRP 205-b (and the UE 115-a) may be configured in accordance with each of the network operation modes 220 during a respective time interval of the second network operation sequence 215-b (e.g., communicate in accordance with the first network operation mode 220-d, the second network operation mode 220-e, and the third network operation mode 220-f during first, second, and third time intervals, respectively). Other network operation modes 220 may include, but are not limited to, additional network energy savings modes, an inactive mode, and the like.

The network operation modes 220 may be associated with different sets of parameters, including a network energy consumption level, a data rate (e.g., a maximum data rate), a data latency, or any combination thereof. In some implementations, each network operation sequence 215 may be associated with a periodicity or a valid duration or time interval. For example, the first network operation sequence 215-a may repeat according to a defined periodicity or for some valid duration or time interval (e.g., repeat after a time interval corresponding to the third network operation mode 220-c). Similarly, the second network operation sequence 215-b may repeat according to a defined periodicity or for some valid duration or time interval (e.g., repeat after a time interval corresponding to the third network operation mode 220-f).

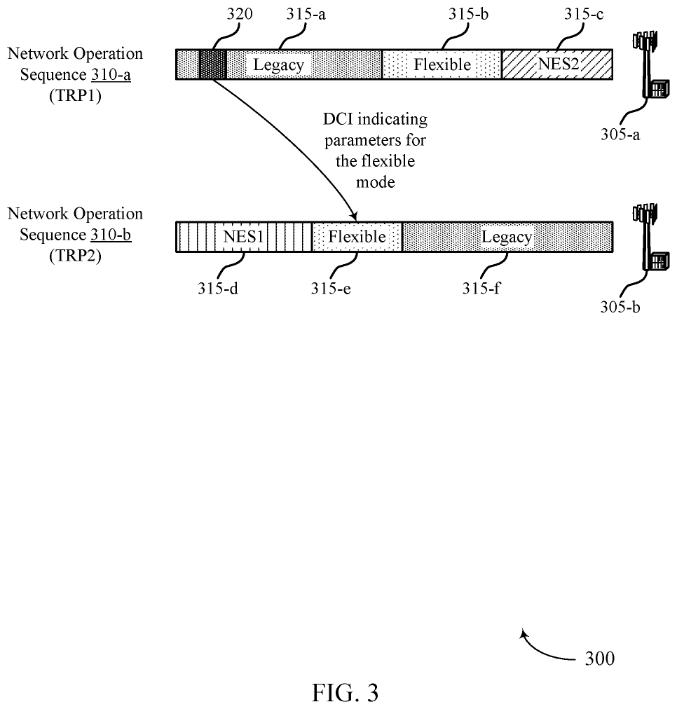

FIG. 3 illustrates an example of a flexible state indication 300 for a flexible mode in accordance with one or more aspects of the present disclosure. A first TRP 305-a may be associated with a first network operation sequence 310-a, and a second TRP 305-b may be associated with a second network operation sequence 310-b. The first network operation sequence 310-a may include a first network operation mode 315-a (e.g., a legacy mode), a second network operation mode 315-b (e.g., a flexible mode), and a third network operation mode 315-c (e.g., a NES2 mode). The second network operation sequence 310-b may include a first network operation mode 315-d (e.g., a NES1 mode), a second network operation mode 315-e (e.g., a flexible mode), and a third network operation mode 315-f (e.g., a legacy mode).

The first TRP 305-a may transmit DCI 320 (e.g., or other control signaling) to a UE 115 including parameters for communicating with the second TRP 305-b in the second network operation mode 315-e (e.g., a flexible mode) at the second TRP 305-b. The parameters for communicating with the second TRP 305-b in the second network operation mode 315-e may be referred to as a flexible state. A flexible state of the second network operation mode 315-e may be indicated via DCI from either the first TRP or the second TRP (e.g., either TRP). An indication of a flexible state may include an indication of a TRP (e.g., a CORESET pool index or a set of virtual component carriers associated with a TRP) for which the flexible state is indicated. The second TRP 305-b may be operating in a NES1 mode (e.g., the first network operation mode 315-d during which the second TRP 305-b may not transmit). As such, if a network determines to indicate a flexible state of the second TRP 305-b, the network may indicate the flexible state of the second TRP 305-b via the first TRP 305-a (e.g., similar to indications for multiple component carriers). One DCI indication may carry information for flexible states of multiple TRPs or multiple component carriers.

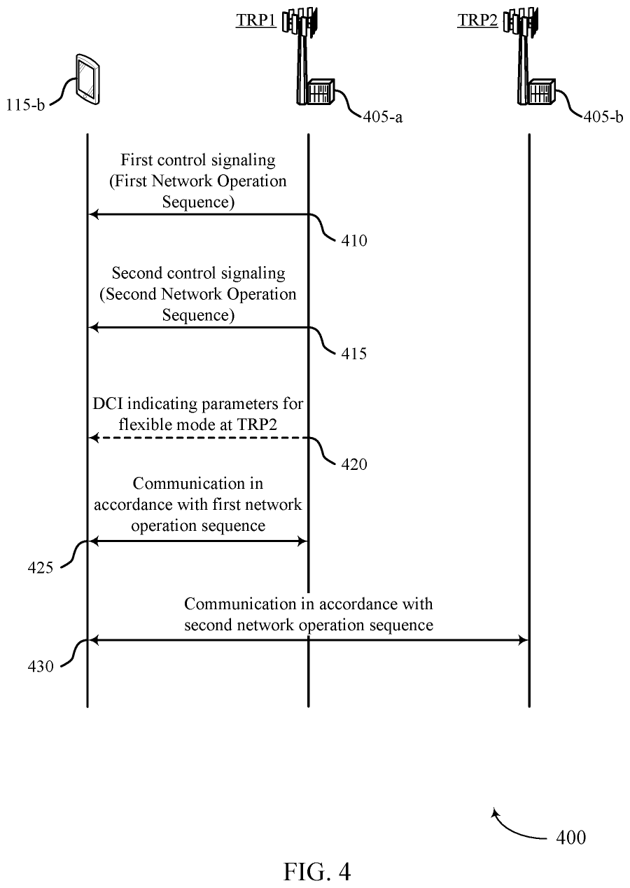

FIG. 4 illustrates an example of a process flow 400 that supports multiple sequences of network operations for multiple transmission and reception points in accordance with one or more aspects of the present disclosure. The process flow 400 includes a UE 115-b, a first TRP 405-a, and a second TRP 405-b, which may be examples of UEs 115, TRPs, network entities 105, and other wireless devices described with reference to FIGS. 1-3. For example, the UE 115-a, the first TRP 205-a, and the second TRP 205-b illustrated in FIG. 2 may be examples of the UE 115-b, the first TRP 405-a, and the second TRP 405-b. In some examples, aspects of the process flow 400 may implement, or be implemented by, aspects of the wireless communications system 100 or the wireless communications system 200. In particular, the process flow 400 illustrates signaling between a UE 115-b, a first TRP 405-a, and a second TRP 405-b that enables network operation sequences to be implemented on a TRP-by-TPR basis, as described with reference to FIGS. 1-3, among other aspects.

In some examples, the operations illustrated in process flow 400 may be performed by hardware (e.g., including circuitry, processing blocks, logic components, and other components), code (e.g., software) executed by a processor, or any combination thereof. Alternative examples of the following may be implemented, where some operations may be performed in a different order than described or may not be performed at all. In some cases, operations may include additional features not mentioned below or further operations may be added.

At 410, the UE 115-b may receive first control signaling (e.g., an RRC message, a DCI message, or a MAC-CE message) indicating a first network operation sequence associated with the first TRP 405-a. For example, the first control signaling may indicate a first identifier (e.g., a first network operation sequence identifier) associated with the first network operation sequence. The first network operation sequence may include a first set of time intervals corresponding to a first set of network operation modes for the first TRP 405-a. The first set of network operation modes may include a first network energy saving mode (e.g., NES1), a second network energy saving mode (e.g., NES2), a flexible mode, a legacy mode, an inactive mode, or any combination thereof.

At 415, the UE 115-b may receive second control signaling (e.g., an RRC message, a DCI message, or a MAC-CE message) indicating a second network operation sequence associated with the second TRP 405-b. For example, the second control signaling may indicate a second identifier (e.g., a second network operation sequence identifier) associated with the second network operation sequence. The second network operation sequence may include a second set of time intervals corresponding to a second set of network operation modes for the second TRP 405-b. The second set of network operation modes may include a first network energy saving mode (e.g., NES1), a second network energy saving mode (e.g., NES2), a flexible mode, a legacy mode, an inactive mode, or any combination thereof.

The first set of time intervals and the first set of network operation modes associated with the first network operation sequence may be different from the second set of time intervals and the second set of network operation modes associated with the second network operation sequence. That is, the first and second sets of network operation modes may not be aligned in a time domain, as shown and described with reference to FIGS. 2 and 3. While the first control signaling at 410 and the second control signaling at 415 are shown and described as separate signaling or messages, this is not to be regarded as a limitation of the present disclosure, unless noted otherwise herein. In this regard, in some implementations, the first control signaling and the second control signaling may be the same. For example, in some implementations, the first network operation sequence and the second network operation sequence may be indicated via a single RRC message (e.g., from the first TRP 405-a, the second TRP 405-b, or another network entity 105).

Moreover, in some implementations, a single TRP may be associated with one or more network operation sequences. In this regard, the first control signaling at 410 or the second control signaling at 415 may indicate multiple potential or candidate network operation sequences for the first TRP 405-a and the second TRP 405-b. For example, the first control signaling may indicate a first set of candidate network operation sequences (including the first network operation sequence) associated with the first TRP 405-a, and the second control signaling may indicate a second set of candidate network operation sequences (including the second network operation sequence) associated with the second TRP 405-b. In some aspects, the first and second network operation sequences may be associated with different sets of parameters or characteristics, including data rates (e.g., maximum or peak data rates), latencies, network energy consumption levels, and the like. Moreover, in some implementations, the first and second network operation sequences may enable or support different types of communications or applications.

In some implementations, the first control signaling or the second control signaling may indicate various parameters associated with the first and second network operation sequences. For example, in some cases, the first control signaling may indicate a first set of parameters associated with the first network operation sequence, and the second control signaling may indicate a second set of parameters associated with the second network operation sequence. In this example, the first and second sets of parameters may include data rates (e.g., peak data rates), latencies, types of supported/un-supported communications, and the like. A set of parameters associated with a network operation sequence may be based on an identifier associated with the network operation sequence (e.g., a network operation sequence ID), the network operation modes associated with or included within the network operation sequence, or any combination thereof.

The UE 115-b, the first TRP 405-a, the second TRP 405-b, or another network entity 105 may select a network operation sequence that may be used for wireless communications for each of the TRPs 405. In particular, in cases where the first TRP 405-a or the second TRP 405-b is associated with multiple candidate network operation sequences, the UE 115-b, the first TRP 405-a, the second TRP 405-b, or another network entity 105 may select which of the network operation sequences to use for a TRP 405. In this regard, the UE 115-b, the first TRP 405-a, the second TRP 405-b, or another network entity 105 may select which network operation sequence may be utilized for a TRP 405 based on receiving or transmitting the first control signaling at 410, the second control signaling at 415, or both.

The UE 115-b, the first TRP 405-a, the second TRP 405-b, or another network entity may select a network operation sequence for a TRP 405 from a set of candidate network operation sequences for the TRP 405 based on one or more parameters or based on a control message (e.g., a DCI message or a MAC-CE message) from the first TRP 405-a, the second TRP 405-b, another network entity 105, or any combination thereof. For example, in some cases, the first TRP 405-a or another network entity 105 may select which network operation sequence to use for the first TRP 405-a based on network traffic conditions or based on a quantity of traffic to be transmitted or received by the UE 115-b, the first TRP 405-a, or another network entity 105, or any combination thereof.

At 420, the UE 115-b may receive, from the first TRP 405-a, DCI including one or more parameters for communicating with the second TRP 405-b during a first time interval. The first time interval may correspond to a flexible mode of a second set of network operation modes for the second TRP 405-b. In some examples, the UE 115-b may receive the DCI in a second time interval corresponding to an active mode of a first set of network operation modes for the first TRP 405-a. The second time interval may overlap with a third time interval corresponding to an inactive mode of the second set of network operation modes for the second TRP 405-b. For instance, the first TRP 405-a may transmit the DCI when the second TRP 405-b is inactive. In some examples, the DCI indicates a second CORESET index or a second set of virtual component carriers associated with the second TRP 405-b. In some examples, the DCI includes multiple sets of parameters for communicating with multiple TRPs during time intervals corresponding to flexible modes. The multiple sets of parameters may include the one or more parameters for communicating with the second TRP 405-b during the first time interval.

At 425, the UE 115-b may communicate with the first TRP 405-a in accordance with the first network operation sequence.

In some examples, the first TRP 405-a may be associated with a first CORESET index or CORESET pool index, and the UE 115-b may communicate with the first TRP 405-a in accordance with the first network operation sequence and based on control information associated with the first CORESET index or CORESET pool index. For instance, during one or more active modes of the first set of network operation modes, the UE 115-b may receive control information associated with the first CORESET index or CORESET pool index, the control information scheduling communications between the UE 115-b and the first TRP 405-a. During one or more inactive modes of the first set of network operation modes, the UE 115-b may avoid receiving control information associated with the first CORESET index or CORESET pool index.

In some examples, the first TRP 405-a may be associated with a first set of virtual component carriers, and the UE 115-b may communicate with the first TRP 405-a on the first set of virtual component carriers in accordance with the first network operation sequence. For instance, the UE 115-b may communicate on the first set of virtual component carriers during one or more active modes of the first set of network operation modes, and the UE 115-b may avoid communicating on the first set of virtual component carriers during one or more inactive modes of the first set of network operation modes. Because the first set of virtual component carriers may correspond to component carriers used by the first TRP 405-a, the UE 115-b may communicate with the first TRP 405-a in accordance with the first network operation sequence.

At 430, the UE 115-b may communicate with the second TRP 405-b in accordance with the second network operation sequence.

In some examples, the second TRP 405-b may be associated with a second CORESET index or CORESET pool index, and the UE 115-b may communicate with the second TRP 405-b in accordance with the second network operation sequence and based on control information associated with the second CORESET index or CORESET pool index. For instance, during one or more active modes of the second set of network operation modes, the UE 115-b may receive control information associated with the second CORESET index or CORESET pool index, the control information scheduling communications between the UE 115-b and the second TRP 405-a. During one or more inactive modes of the second set of network operation modes, the UE 115-b may avoid receiving control information associated with the second CORESET index or CORESET pool index.

In some examples, the second TRP 405-b may be associated with a second set of virtual component carriers, and the UE 115-b may communicate with the second TRP 405-b on the second set of virtual component carriers in accordance with the second network operation sequence. For instance, the UE 115-b may communicate on the second set of virtual component carriers during one or more active modes of the second set of network operation modes, and the UE 115-b may avoid communicating on the second set of virtual component carriers during one or more inactive modes of the second set of network operation modes. Because the second set of virtual component carriers may correspond to component carriers used by the second TRP 405-b, the UE 115-b may communicate with the second TRP 405-b in accordance with the second network operation sequence.

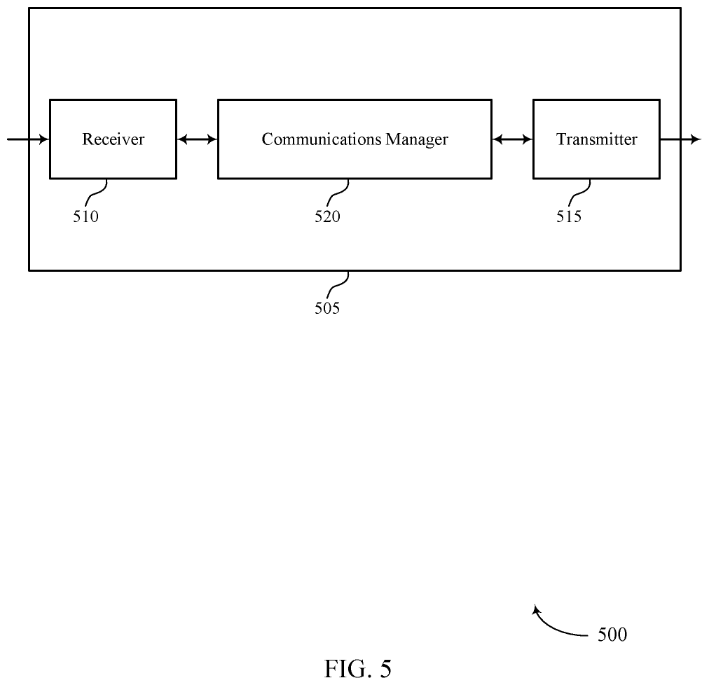

FIG. 5 shows a block diagram 500 of a device 505 that supports multiple sequences of network operations for multiple transmission and reception points in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to multiple sequences of network operations for multiple transmission and reception points). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to multiple sequences of network operations for multiple transmission and reception points). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of multiple sequences of network operations for multiple transmission and reception points as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving first control signaling indicating a first network operation sequence associated with a first network entity, the first network operation sequence including a first set of time intervals corresponding to a first set of network operation modes for the first network entity. The communications manager 520 may be configured as or otherwise support a means for receiving second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively. The communications manager 520 may be configured as or otherwise support a means for communicating with the first network entity in accordance with the first network operation sequence. The communications manager 520 may be configured as or otherwise support a means for communicating with the second network entity in accordance with the second network operation sequence.

By including or configuring the communications manager 520 in accordance with examples as described herein, the device 505 (e.g., a processor controlling or otherwise coupled with the receiver 510, the transmitter 515, the communications manager 520, or any combination thereof) may support techniques for reduced processing and reduced power consumption. The described techniques may enable the device 505 to implement network operation sequences on a TRP-by-TRP basis. As such, the device 505 may communicate with a TRP in accordance with a network operation sequence configured for the TRP, and the network operation sequence configured for the TRP may be adapted to minimize processing and power consumption in a network or at the device 505.

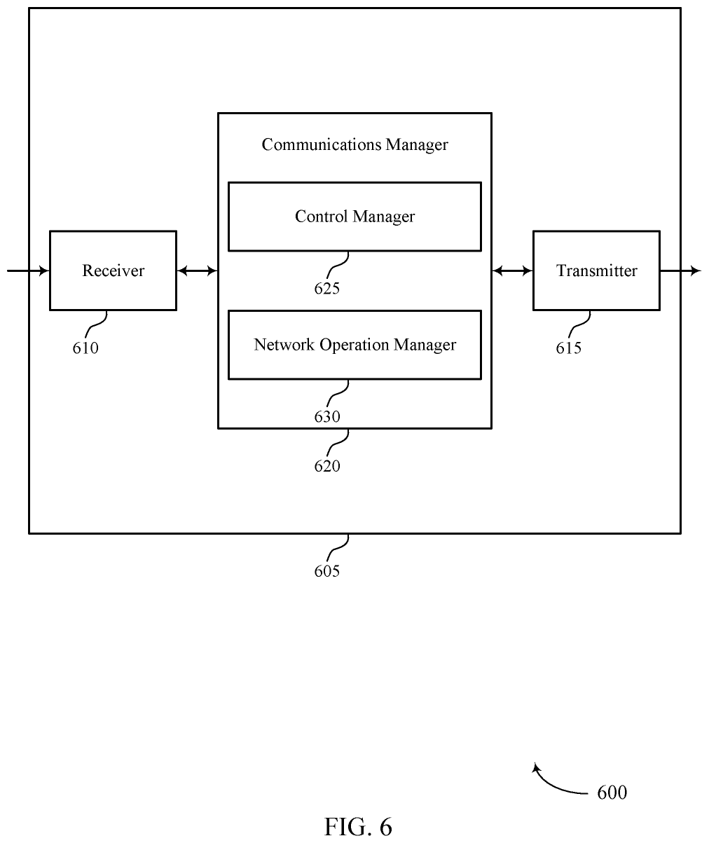

FIG. 6 shows a block diagram 600 of a device 605 that supports multiple sequences of network operations for multiple transmission and reception points in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to multiple sequences of network operations for multiple transmission and reception points). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to multiple sequences of network operations for multiple transmission and reception points). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of multiple sequences of network operations for multiple transmission and reception points as described herein. For example, the communications manager 620 may include a control manager 625 a network operation manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The control manager 625 may be configured as or otherwise support a means for receiving first control signaling indicating a first network operation sequence associated with a first network entity, the first network operation sequence including a first set of time intervals corresponding to a first set of network operation modes for the first network entity. The control manager 625 may be configured as or otherwise support a means for receiving second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively. The network operation manager 630 may be configured as or otherwise support a means for communicating with the first network entity in accordance with the first network operation sequence. The network operation manager 630 may be configured as or otherwise support a means for communicating with the second network entity in accordance with the second network operation sequence.

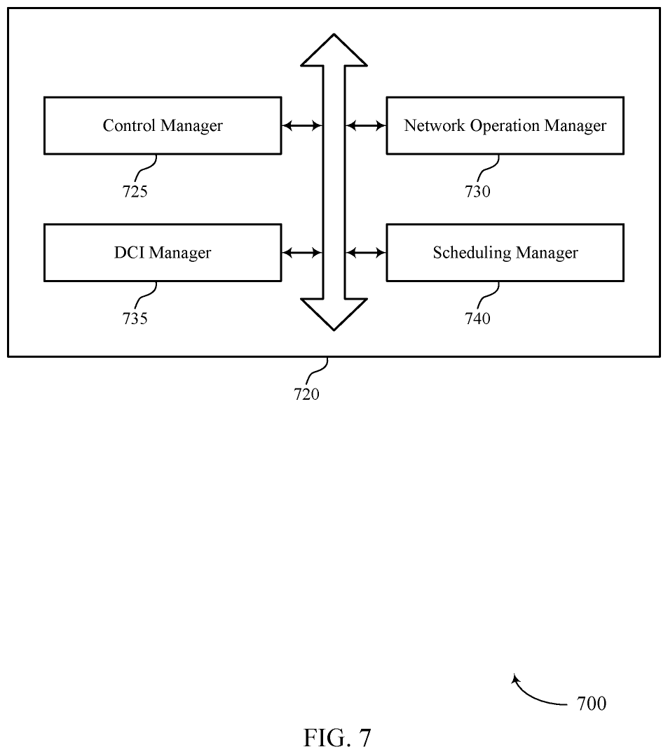

FIG. 7 shows a block diagram 700 of a communications manager 720 that supports multiple sequences of network operations for multiple transmission and reception points in accordance with one or more aspects of the present disclosure. The communications manager 720 may be an example of aspects of a communications manager 520, a communications manager 620, or both, as described herein. The communications manager 720, or various components thereof, may be an example of means for performing various aspects of multiple sequences of network operations for multiple transmission and reception points as described herein. For example, the communications manager 720 may include a control manager 725, a network operation manager 730, a DCI manager 735, a scheduling manager 740, or any combination thereof. Each of these components may communicate, directly or indirectly, with one another (e.g., via one or more buses).

The communications manager 720 may support wireless communication at a UE in accordance with examples as disclosed herein. The control manager 725 may be configured as or otherwise support a means for receiving first control signaling indicating a first network operation sequence associated with a first network entity, the first network operation sequence including a first set of time intervals corresponding to a first set of network operation modes for the first network entity. In some examples, the control manager 725 may be configured as or otherwise support a means for receiving second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively. The network operation manager 730 may be configured as or otherwise support a means for communicating with the first network entity in accordance with the first network operation sequence. In some examples, the network operation manager 730 may be configured as or otherwise support a means for communicating with the second network entity in accordance with the second network operation sequence.

In some examples, to support communicating with the first network entity, the network operation manager 730 may be configured as or otherwise support a means for communicating with the first network entity in accordance with the first network operation sequence and based on control information associated with the first control resource set index.

In some examples, to support communicating with the first network entity based on control information associated with the first control resource set index, the scheduling manager 740 may be configured as or otherwise support a means for receiving, during one or more active modes of the first set of network operation modes, control information associated with the first control resource set index.

In some examples, to support communicating with the first network entity based on control information associated with the first control resource set index, the scheduling manager 740 may be configured as or otherwise support a means for avoiding receiving, during one or more inactive modes of the first set of network operation modes, control information associated with the first control resource set index.

In some examples, to support communicating with the first network entity, the network operation manager 730 may be configured as or otherwise support a means for communicating with the first network entity on the first set of virtual component carriers in accordance with the first network operation sequence.

In some examples, the DCI manager 735 may be configured as or otherwise support a means for receiving, from the first network entity, downlink control information including one or more parameters for communicating with the second network entity during a first time interval, the first time interval corresponding to a flexible mode of the second set of network operation modes for the second network entity.

In some examples, to support receiving the downlink control information, the DCI manager 735 may be configured as or otherwise support a means for receiving the downlink control information in a second time interval corresponding to an active mode of the first set of network operation modes for the first network entity, the second time interval overlapping with a third time interval corresponding to an inactive mode of the second set of network operation modes for the second network entity.

In some examples, the downlink control information indicates a second control resource set index or a second set of virtual component carriers associated with the second network entity.

In some examples, the downlink control information includes multiple sets of parameters for communicating with multiple network entities during time intervals corresponding to flexible modes, the multiple sets of parameters including the one or more parameters for communicating with the second network entity during the first time interval.

In some examples, the first network operation sequence is associated with a first set of parameters. In some examples, the second network operation sequence is associated with a second set of parameters different from the first set of parameters. In some examples, the first set of parameters, the second set of parameters, or both, include a network energy consumption level, a maximum data rate, or both.

In some examples, the first control signaling is the same as the second control signaling.

In some examples, the first set of network operation modes, the second set of network operation modes, or both, include a first network energy saving mode, a second network energy saving mode, a flexible mode, a legacy mode, an inactive mode, or any combination thereof.

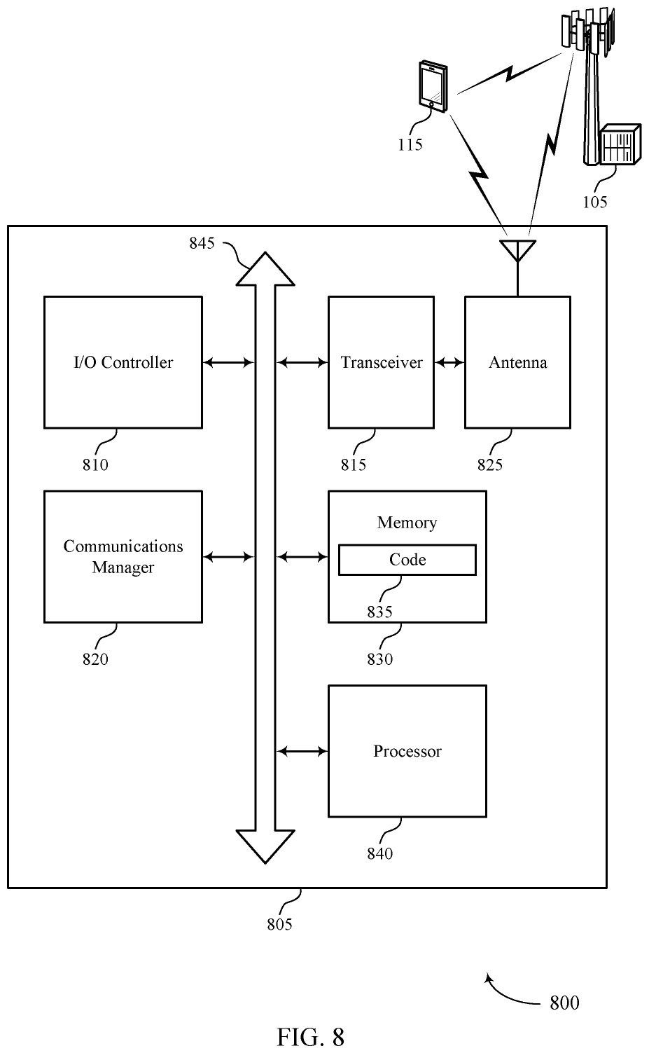

FIG. 8 shows a diagram of a system 800 including a device 805 that supports multiple sequences of network operations for multiple transmission and reception points in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting multiple sequences of network operations for multiple transmission and reception points). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving first control signaling indicating a first network operation sequence associated with a first network entity, the first network operation sequence including a first set of time intervals corresponding to a first set of network operation modes for the first network entity. The communications manager 820 may be configured as or otherwise support a means for receiving second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively. The communications manager 820 may be configured as or otherwise support a means for communicating with the first network entity in accordance with the first network operation sequence. The communications manager 820 may be configured as or otherwise support a means for communicating with the second network entity in accordance with the second network operation sequence.

By including or configuring the communications manager 820 in accordance with examples as described herein, the device 805 may support techniques for reduced processing and reduced power consumption. The described techniques may enable the device 805 to implement network operation sequences on a TRP-by-TRP basis. As such, the device 805 may communicate with a TRP in accordance with a network operation sequence configured for the TRP, and the network operation sequence configured for the TRP may be adapted to minimize processing and power consumption in a network or at the device 805.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of multiple sequences of network operations for multiple transmission and reception points as described herein, or the processor 840 and the memory 830 may be otherwise configured to perform or support such operations.

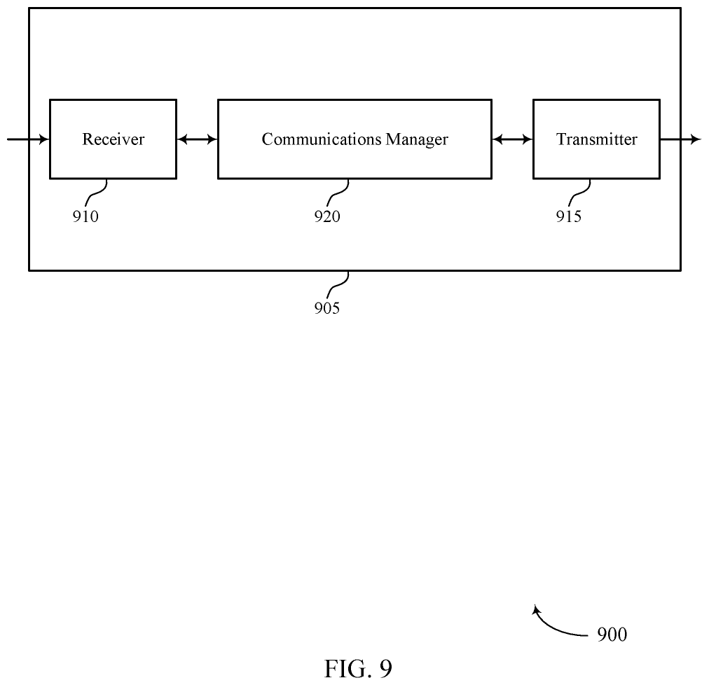

FIG. 9 shows a block diagram 900 of a device 905 that supports multiple sequences of network operations for multiple transmission and reception points in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of multiple sequences of network operations for multiple transmission and reception points as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a first network entity in accordance with examples as disclosed herein. For example, the communications manager 920 may be configured as or otherwise support a means for transmitting, to a UE, first control signaling indicating a first network operation sequence associated with the first network entity, the first network operation sequence including a first set of time intervals corresponding to a first set of network operation modes for the first network entity. The communications manager 920 may be configured as or otherwise support a means for transmitting, to the UE, second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively. The communications manager 920 may be configured as or otherwise support a means for communicating with the UE in accordance with the first network operation sequence.

By including or configuring the communications manager 920 in accordance with examples as described herein, the device 905 (e.g., a processor controlling or otherwise coupled with the receiver 910, the transmitter 915, the communications manager 920, or any combination thereof) may support techniques for reduced processing and reduced power consumption. The described techniques may enable the device 905 or a TRP to implement network operation sequences on a TRP-by-TRP basis. As such, the device 905 or the TRP may communicate with a UE in accordance with a network operation sequence configured at the device 905 or the TRP, and the network operation sequence configured for the device 905 or the TRP may be adapted to minimize processing and power consumption in a network, at the device 905, or at the TRP.

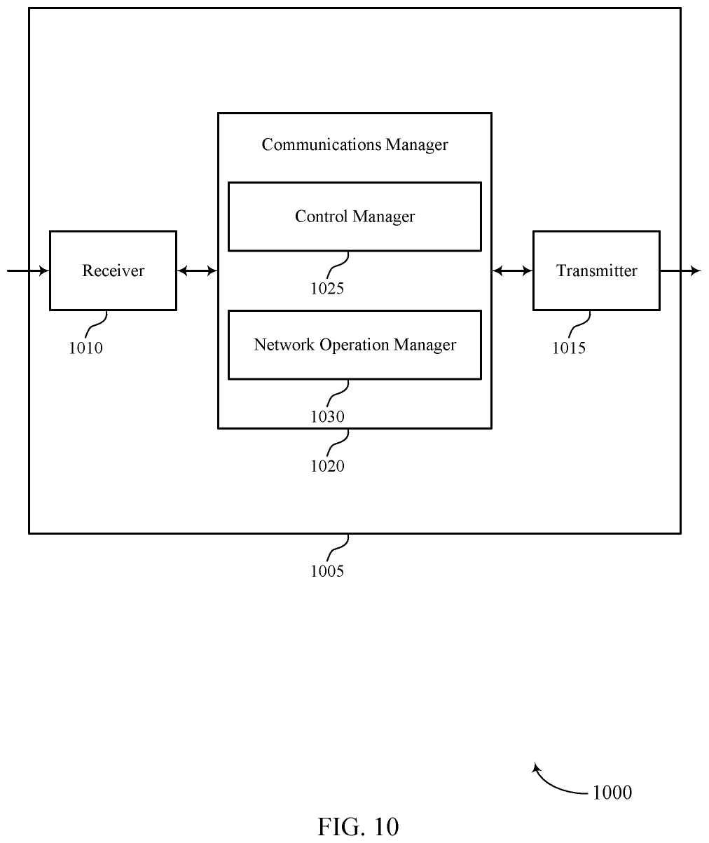

FIG. 10 shows a block diagram 1000 of a device 1005 that supports multiple sequences of network operations for multiple transmission and reception points in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of multiple sequences of network operations for multiple transmission and reception points as described herein. For example, the communications manager 1020 may include a control manager 1025 a network operation manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a first network entity in accordance with examples as disclosed herein. The control manager 1025 may be configured as or otherwise support a means for transmitting, to a UE, first control signaling indicating a first network operation sequence associated with the first network entity, the first network operation sequence including a first set of time intervals corresponding to a first set of network operation modes for the first network entity. The control manager 1025 may be configured as or otherwise support a means for transmitting, to the UE, second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively. The network operation manager 1030 may be configured as or otherwise support a means for communicating with the UE in accordance with the first network operation sequence.

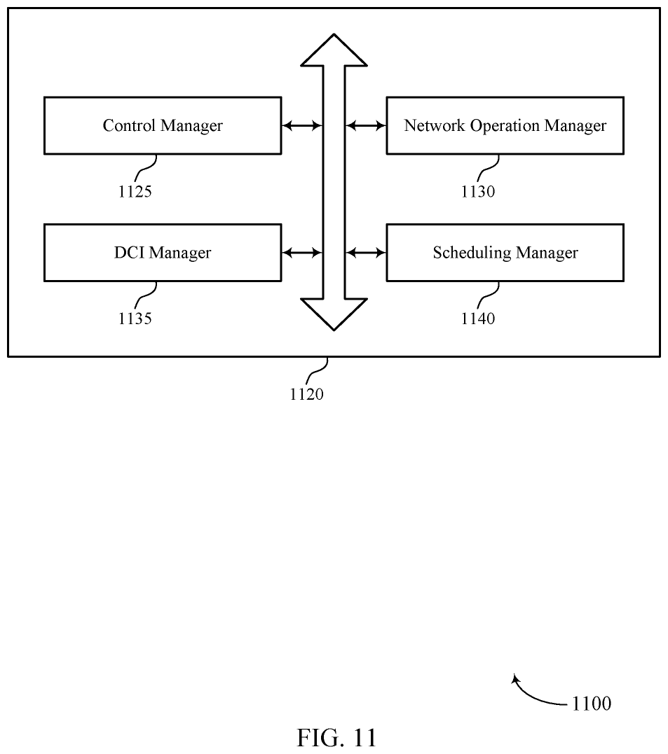

FIG. 11 shows a block diagram 1100 of a communications manager 1120 that supports multiple sequences of network operations for multiple transmission and reception points in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of multiple sequences of network operations for multiple transmission and reception points as described herein. For example, the communications manager 1120 may include a control manager 1125, a network operation manager 1130, a DCI manager 1135, a scheduling manager 1140, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a first network entity in accordance with examples as disclosed herein. The control manager 1125 may be configured as or otherwise support a means for transmitting, to a UE, first control signaling indicating a first network operation sequence associated with the first network entity, the first network operation sequence including a first set of time intervals corresponding to a first set of network operation modes for the first network entity. In some examples, the control manager 1125 may be configured as or otherwise support a means for transmitting, to the UE, second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively. The network operation manager 1130 may be configured as or otherwise support a means for communicating with the UE in accordance with the first network operation sequence.

In some examples, to support communicating with the UE, the network operation manager 1130 may be configured as or otherwise support a means for communicating with the UE in accordance with the first network operation sequence and based on control information associated with the first control resource set index.

In some examples, to support communicating with the UE based on control information associated with the first control resource set index, the scheduling manager 1140 may be configured as or otherwise support a means for transmitting, during one or more active modes of the first set of network operation modes, control information associated with the first control resource set index.

In some examples, to support communicating with the UE based on control information associated with the first control resource set index, the scheduling manager 1140 may be configured as or otherwise support a means for avoiding transmitting, during one or more inactive modes of the first set of network operation modes, control information associated with the first control resource set index.

In some examples, to support communicating with the UE, the network operation manager 1130 may be configured as or otherwise support a means for communicating with the UE on the first set of virtual component carriers in accordance with the first network operation sequence.

In some examples, the DCI manager 1135 may be configured as or otherwise support a means for transmitting, to the UE, downlink control information including one or more parameters for communicating with the second network entity during a first time interval, the first time interval corresponding to a flexible mode of the second set of network operation modes for the second network entity.

In some examples, to support transmitting the downlink control information, the DCI manager 1135 may be configured as or otherwise support a means for transmitting the downlink control information in a second time interval corresponding to an active mode of the first set of network operation modes for the first network entity, the second time interval overlapping with a third time interval corresponding to an inactive mode of the second set of network operation modes for the second network entity.

In some examples, the downlink control information indicates a second control resource set index or a second set of virtual component carriers associated with the second network entity.

In some examples, the downlink control information includes multiple sets of parameters for communicating with multiple network entities during time intervals corresponding to flexible modes, the multiple sets of parameters including the one or more parameters for communicating with the second network entity during the first time interval.

In some examples, the first network operation sequence is associated with a first set of parameters. In some examples, the second network operation sequence is associated with a second set of parameters different from the first set of parameters. In some examples, the first set of parameters, the second set of parameters, or both, include a network energy consumption level, a maximum data rate, or both.

In some examples, the first control signaling is the same as the second control signaling.

In some examples, the first set of network operation modes, the second set of network operation modes, or both, include a first network energy saving mode, a second network energy saving mode, a flexible mode, a legacy mode, an inactive mode, or any combination thereof.

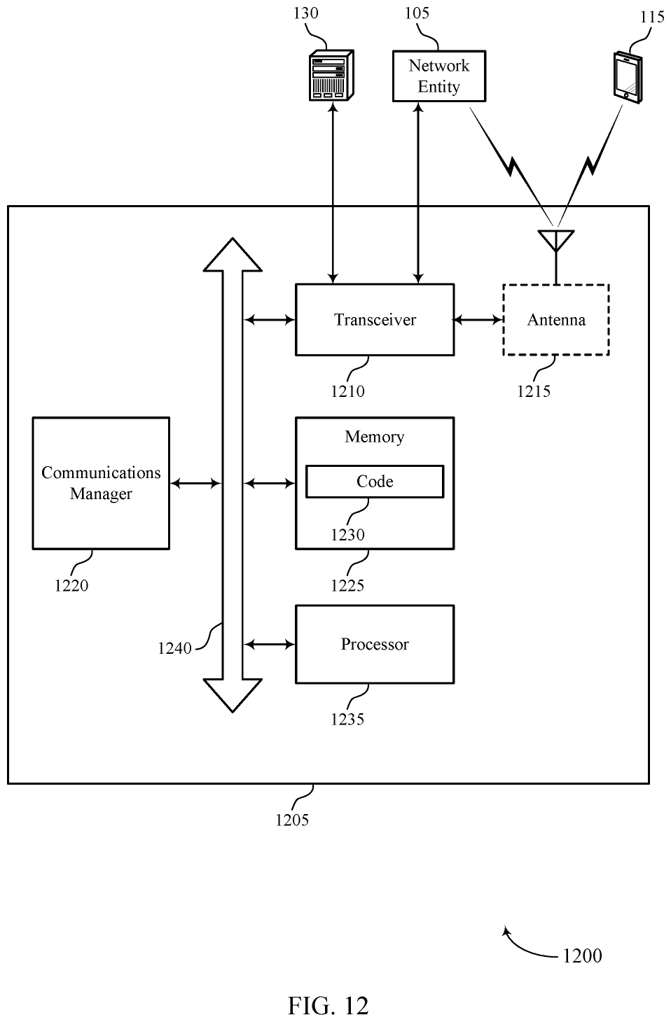

FIG. 12 shows a diagram of a system 1200 including a device 1205 that supports multiple sequences of network operations for multiple transmission and reception points in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or any combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting multiple sequences of network operations for multiple transmission and reception points). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a first network entity in accordance with examples as disclosed herein. For example, the communications manager 1220 may be configured as or otherwise support a means for transmitting, to a UE, first control signaling indicating a first network operation sequence associated with the first network entity, the first network operation sequence including a first set of time intervals corresponding to a first set of network operation modes for the first network entity. The communications manager 1220 may be configured as or otherwise support a means for transmitting, to the UE, second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively. The communications manager 1220 may be configured as or otherwise support a means for communicating with the UE in accordance with the first network operation sequence.

By including or configuring the communications manager 1220 in accordance with examples as described herein, the device 1205 may support techniques for reduced processing and reduced power consumption. The described techniques may enable the device 1205 or a TRP to implement network operation sequences on a TRP-by-TRP basis. As such, the device 1205 or the TRP may communicate with a UE in accordance with a network operation sequence configured at the device 1205 or the TRP, and the network operation sequence configured for the device 1205 or the TRP may be adapted to minimize processing and power consumption in a network, at the device 1205, or at the TRP.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of multiple sequences of network operations for multiple transmission and reception points as described herein, or the processor 1235 and the memory 1225 may be otherwise configured to perform or support such operations.

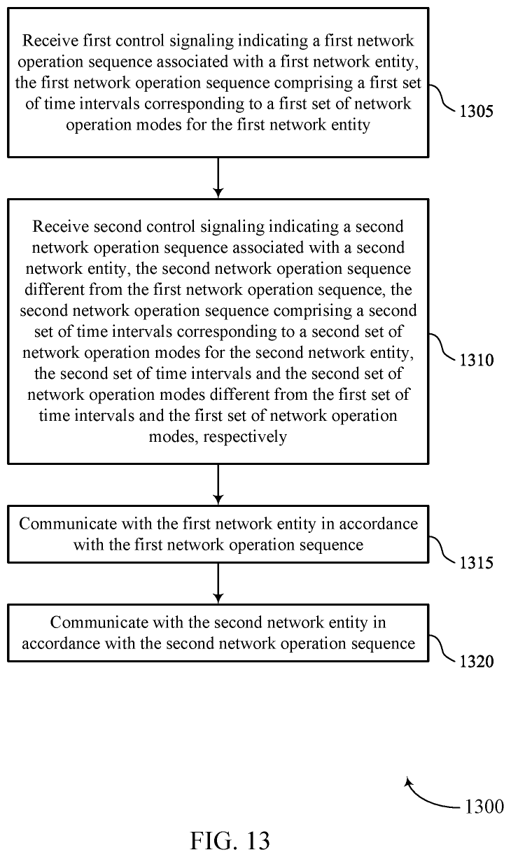

FIG. 13 shows a flowchart illustrating a method 1300 that supports multiple sequences of network operations for multiple transmission and reception points in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving first control signaling indicating a first network operation sequence associated with a first network entity, the first network operation sequence including a first set of time intervals corresponding to a first set of network operation modes for the first network entity. The operations of 1305 may be performed in accordance with examples as disclosed herein. In some examples, aspects of the operations of 1305 may be performed by a control manager 725 as described with reference to FIG. 7.

At 1310, the method may include receiving second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively. The operations of 1310 may be performed in accordance with examples as disclosed herein. In some examples, aspects of the operations of 1310 may be performed by a control manager 725 as described with reference to FIG. 7.

At 1315, the method may include communicating with the first network entity in accordance with the first network operation sequence. The operations of 1315 may be performed in accordance with examples as disclosed herein. In some examples, aspects of the operations of 1315 may be performed by a network operation manager 730 as described with reference to FIG. 7.

At 1320, the method may include communicating with the second network entity in accordance with the second network operation sequence. The operations of 1320 may be performed in accordance with examples as disclosed herein. In some examples, aspects of the operations of 1320 may be performed by a network operation manager 730 as described with reference to FIG. 7.

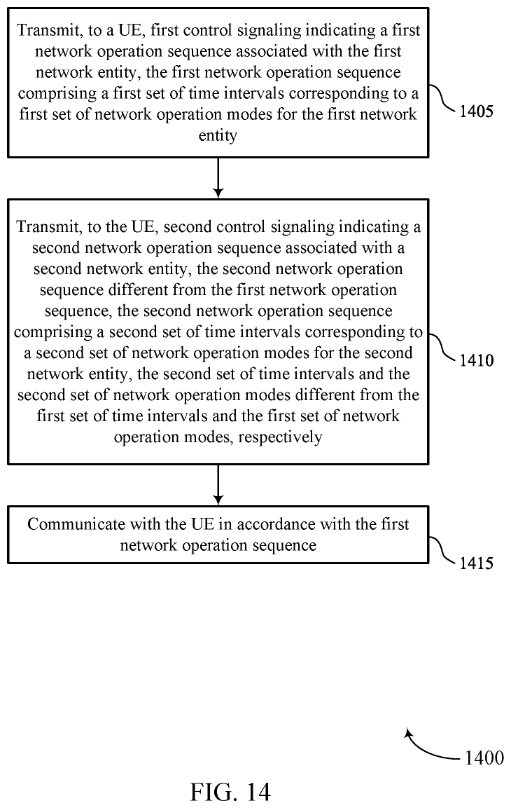

FIG. 14 shows a flowchart illustrating a method 1400 that supports multiple sequences of network operations for multiple transmission and reception points in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting, to a UE, first control signaling indicating a first network operation sequence associated with the first network entity, the first network operation sequence including a first set of time intervals corresponding to a first set of network operation modes for the first network entity. The operations of 1405 may be performed in accordance with examples as disclosed herein. In some examples, aspects of the operations of 1405 may be performed by a control manager 1125 as described with reference to FIG. 11.

At 1410, the method may include transmitting, to the UE, second control signaling indicating a second network operation sequence associated with a second network entity, the second network operation sequence different from the first network operation sequence, the second network operation sequence including a second set of time intervals corresponding to a second set of network operation modes for the second network entity, the second set of time intervals and the second set of network operation modes different from the first set of time intervals and the first set of network operation modes, respectively. The operations of 1410 may be performed in accordance with examples as disclosed herein. In some examples, aspects of the operations of 1410 may be performed by a control manager 1125 as described with reference to FIG. 11.

At 1415, the method may include communicating with the UE in accordance with the first network operation sequence. The operations of 1415 may be performed in accordance with examples as disclosed herein. In some examples, aspects of the operations of 1415 may be performed by a network operation manager 1130 as described with reference to FIG. 11.

The following provides an overview of aspects of the present disclosure:

Aspect 1: A method for wireless communication at a UE, comprising: receiving first control signaling indicating a first network operation sequence associated with a first network entity, the first network operation sequence comprising a first set of time intervals corresponding to a first set of network operation modes for the first network entity; receiving second control signaling indicating a second network operation sequence associated with a second network entity, the second network operation sequence different from the first network operation sequence, the second network operation sequence comprising a second set of time intervals corresponding to a second set of network operation modes for the second network entity, the second set of time intervals and the second set of network operation modes different from the first set of time intervals and the first set of network operation modes, respectively; communicating with the first network entity in accordance with the first network operation sequence; and communicating with the second network entity in accordance with the second network operation sequence.

Aspect 2: The method of aspect 1, wherein the first network entity is associated with a first control resource set index, and wherein communicating with the first network entity comprises: communicating with the first network entity in accordance with the first network operation sequence and based at least in part on control information associated with the first control resource set index.

Aspect 3: The method of aspect 2, wherein communicating with the first network entity based at least in part on control information associated with the first control resource set index comprises: receiving, during one or more active modes of the first set of network operation modes, control information associated with the first control resource set index.

Aspect 4: The method of any of aspects 2 through 3, wherein communicating with the first network entity based at least in part on control information associated with the first control resource set index comprises: avoiding receiving, during one or more inactive modes of the first set of network operation modes, control information associated with the first control resource set index.

Aspect 5: The method of any of aspects 1 through 4, wherein the first network entity is associated with a first set of virtual component carriers, and wherein communicating with the first network entity comprises: communicating with the first network entity on the first set of virtual component carriers in accordance with the first network operation sequence.

Aspect 6: The method of any of aspects 1 through 5, further comprising: receiving, from the first network entity, downlink control information comprising one or more parameters for communicating with the second network entity during a first time interval, the first time interval corresponding to a flexible mode of the second set of network operation modes for the second network entity.

Aspect 7: The method of aspect 6, wherein receiving the downlink control information comprises: receiving the downlink control information in a second time interval corresponding to an active mode of the first set of network operation modes for the first network entity, the second time interval overlapping with a third time interval corresponding to an inactive mode of the second set of network operation modes for the second network entity.

Aspect 8: The method of any of aspects 6 through 7, wherein the downlink control information indicates a second control resource set index or a second set of virtual component carriers associated with the second network entity.

Aspect 9: The method of any of aspects 6 through 8, wherein the downlink control information comprises multiple sets of parameters for communicating with multiple network entities during time intervals corresponding to flexible modes, the multiple sets of parameters comprising the one or more parameters for communicating with the second network entity during the first time interval.

Aspect 10: The method of any of aspects 1 through 9, wherein the first network operation sequence is associated with a first set of parameters, and the second network operation sequence is associated with a second set of parameters different from the first set of parameters, the first set of parameters, the second set of parameters, or both, comprise a network energy consumption level, a maximum data rate, or both.

Aspect 11: The method of any of aspects 1 through 10, wherein the first control signaling is the same as the second control signaling.

Aspect 12: The method of any of aspects 1 through 11, wherein the first set of network operation modes, the second set of network operation modes, or both, comprise a first network energy saving mode, a second network energy saving mode, a flexible mode, a legacy mode, an inactive mode, or any combination thereof.

Aspect 13: A method for wireless communication at a first network entity, comprising: transmitting, to a UE, first control signaling indicating a first network operation sequence associated with the first network entity, the first network operation sequence comprising a first set of time intervals corresponding to a first set of network operation modes for the first network entity; transmitting, to the UE, second control signaling indicating a second network operation sequence associated with a second network entity, the second network operation sequence different from the first network operation sequence, the second network operation sequence comprising a second set of time intervals corresponding to a second set of network operation modes for the second network entity, the second set of time intervals and the second set of network operation modes different from the first set of time intervals and the first set of network operation modes, respectively; and communicating with the UE in accordance with the first network operation sequence.

Aspect 14: The method of aspect 13, wherein the first network entity is associated with a first control resource set index, and wherein communicating with the UE comprises: communicating with the UE in accordance with the first network operation sequence and based at least in part on control information associated with the first control resource set index.

Aspect 15: The method of aspect 14, wherein communicating with the UE based at least in part on control information associated with the first control resource set index comprises: transmitting, during one or more active modes of the first set of network operation modes, control information associated with the first control resource set index.

Aspect 16: The method of any of aspects 14 through 15, wherein communicating with the UE based at least in part on control information associated with the first control resource set index comprises: avoiding transmitting, during one or more inactive modes of the first set of network operation modes, control information associated with the first control resource set index.

Aspect 17: The method of any of aspects 13 through 16, wherein the first network entity is associated with a first set of virtual component carriers, and wherein communicating with the UE comprises: communicating with the UE on the first set of virtual component carriers in accordance with the first network operation sequence.

Aspect 18: The method of any of aspects 13 through 17, further comprising: transmitting, to the UE, downlink control information comprising one or more parameters for communicating with the second network entity during a first time interval, the first time interval corresponding to a flexible mode of the second set of network operation modes for the second network entity.

Aspect 19: The method of aspect 18, wherein transmitting the downlink control information comprises: transmitting the downlink control information in a second time interval corresponding to an active mode of the first set of network operation modes for the first network entity, the second time interval overlapping with a third time interval corresponding to an inactive mode of the second set of network operation modes for the second network entity.

Aspect 20: The method of any of aspects 18 through 19, wherein the downlink control information indicates a second control resource set index or a second set of virtual component carriers associated with the second network entity.

Aspect 21: The method of any of aspects 18 through 20, wherein the downlink control information comprises multiple sets of parameters for communicating with multiple network entities during time intervals corresponding to flexible modes, the multiple sets of parameters comprising the one or more parameters for communicating with the second network entity during the first time interval.

Aspect 22: The method of any of aspects 13 through 21, wherein the first network operation sequence is associated with a first set of parameters, and the second network operation sequence is associated with a second set of parameters different from the first set of parameters, the first set of parameters, the second set of parameters, or both, comprise a network energy consumption level, a maximum data rate, or both.

Aspect 23: The method of any of aspects 13 through 22, wherein the first control signaling is the same as the second control signaling.

Aspect 24: The method of any of aspects 13 through 23, wherein the first set of network operation modes, the second set of network operation modes, or both, comprise a first network energy saving mode, a second network energy saving mode, a flexible mode, a legacy mode, an inactive mode, or any combination thereof.

Aspect 25: An apparatus for wireless communication at a UE, comprising a processor; memory coupled with the processor; and instructions stored in the memory and executable by the processor to cause the apparatus to perform a method of any of aspects 1 through 12.

Aspect 26: An apparatus for wireless communication at a UE, comprising at least one means for performing a method of any of aspects 1 through 12.

Aspect 27: A non-transitory computer-readable medium storing code for wireless communication at a UE, the code comprising instructions executable by a processor to perform a method of any of aspects 1 through 12.

Aspect 28: An apparatus for wireless communication at a first network entity, comprising a processor; memory coupled with the processor; and instructions stored in the memory and executable by the processor to cause the apparatus to perform a method of any of aspects 13 through 24.

Aspect 29: An apparatus for wireless communication at a first network entity, comprising at least one means for performing a method of any of aspects 13 through 24.

Aspect 30: A non-transitory computer-readable medium storing code for wireless communication at a first network entity, the code comprising instructions executable by a processor to perform a method of any of aspects 13 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor; and
memory coupled with the processor, with instructions stored in the memory, the instructions being executable by the processor to cause the apparatus to:
receive first control signaling indicating a first network operation sequence associated with a first network entity, the first network operation sequence comprising a first set of time intervals corresponding to a first set of network operation modes for the first network entity;
receive second control signaling indicating a second network operation sequence associated with a second network entity, the second network operation sequence different from the first network operation sequence, the second network operation sequence comprising a second set of time intervals corresponding to a second set of network operation modes for the second network entity, the second set of time intervals and the second set of network operation modes different from the first set of time intervals and the first set of network operation modes, respectively;
communicate with the first network entity in accordance with the first network operation sequence; and
communicate with the second network entity in accordance with the second network operation sequence.

2. The apparatus of claim 1, wherein the first network entity is associated with a first control resource set index, and wherein the instructions to communicate with the first network entity are executable by the processor to cause the apparatus to:
communicate with the first network entity in accordance with the first network operation sequence and based at least in part on control information associated with the first control resource set index.

3. The apparatus of claim 2, wherein the instructions to communicate with the first network entity based at least in part on control information associated with the first control resource set index are executable by the processor to cause the apparatus to:
receive, during one or more active modes of the first set of network operation modes, control information associated with the first control resource set index.

4. The apparatus of claim 2, wherein the instructions to communicate with the first network entity based at least in part on control information associated with the first control resource set index are executable by the processor to cause the apparatus to:
avoid receiving, during one or more inactive modes of the first set of network operation modes, control information associated with the first control resource set index.

5. The apparatus of claim 1, wherein the first network entity is associated with a first set of virtual component carriers, and wherein the instructions to communicate with the first network entity are executable by the processor to cause the apparatus to:
communicate with the first network entity on the first set of virtual component carriers in accordance with the first network operation sequence.

6. The apparatus of claim 1, wherein the instructions are further executable by the processor to cause the apparatus to:
receive, from the first network entity, downlink control information comprising one or more parameters for communicating with the second network entity during a first time interval, the first time interval corresponding to a flexible mode of the second set of network operation modes for the second network entity.

7. The apparatus of claim 6, wherein the instructions to receive the downlink control information are executable by the processor to cause the apparatus to:
receive the downlink control information in a second time interval corresponding to an active mode of the first set of network operation modes for the first network entity, the second time interval overlapping with a third time interval corresponding to an inactive mode of the second set of network operation modes for the second network entity.

8. The apparatus of claim 6, wherein the downlink control information indicates a second control resource set index or a second set of virtual component carriers associated with the second network entity.

9. The apparatus of claim 6, wherein the downlink control information comprises multiple sets of parameters for communicating with multiple network entities during time intervals corresponding to flexible modes, the multiple sets of parameters comprising the one or more parameters for communicating with the second network entity during the first time interval.

10. The apparatus of claim 1, wherein the first network operation sequence is associated with a first set of parameters, and wherein the second network operation sequence is associated with a second set of parameters different from the first set of parameters, the first set of parameters, the second set of parameters, or both, comprising a network energy consumption level, a maximum data rate, or both.

11. The apparatus of claim 1, wherein the first control signaling is the same as the second control signaling.

12. The apparatus of claim 1, wherein the first set of network operation modes, the second set of network operation modes, or both, comprise a first network energy saving mode, a second network energy saving mode, a flexible mode, a legacy mode, an inactive mode, or any combination thereof.

13. An apparatus for wireless communication at a first network entity, comprising:
a processor; and
memory coupled with the processor, with instructions stored in the memory, the instructions being executable by the processor to cause the apparatus to:
transmit, to a user equipment (UE), first control signaling indicating a first network operation sequence associated with the first network entity, the first network operation sequence comprising a first set of time intervals corresponding to a first set of network operation modes for the first network entity;
transmit, to the UE, second control signaling indicating a second network operation sequence associated with a second network entity, the second network operation sequence different from the first network operation sequence, the second network operation sequence comprising a second set of time intervals corresponding to a second set of network operation modes for the second network entity, the second set of time intervals and the second set of network operation modes different from the first set of time intervals and the first set of network operation modes, respectively; and
communicate with the UE in accordance with the first network operation sequence.

14. The apparatus of claim 13, wherein the first network entity is associated with a first control resource set index, and wherein the instructions to communicate with the UE are executable by the processor to cause the apparatus to:
communicate with the UE in accordance with the first network operation sequence and based at least in part on control information associated with the first control resource set index.

15. The apparatus of claim 14, wherein the instructions to communicate with the UE based at least in part on control information associated with the first control resource set index are executable by the processor to cause the apparatus to:
transmit, during one or more active modes of the first set of network operation modes, control information associated with the first control resource set index.

16. The apparatus of claim 14, wherein the instructions to communicate with the UE based at least in part on control information associated with the first control resource set index are executable by the processor to cause the apparatus to:
avoid transmitting, during one or more inactive modes of the first set of network operation modes, control information associated with the first control resource set index.

17. The apparatus of claim 13, wherein the first network entity is associated with a first set of virtual component carriers, and wherein the instructions to communicate with the UE are executable by the processor to cause the apparatus to:
communicate with the UE on the first set of virtual component carriers in accordance with the first network operation sequence.

18. The apparatus of claim 13, wherein the instructions are further executable by the processor to cause the apparatus to:
transmit, to the UE, downlink control information comprising one or more parameters for communicating with the second network entity during a first time interval, the first time interval corresponding to a flexible mode of the second set of network operation modes for the second network entity.

19. The apparatus of claim 18, wherein the instructions to transmit the downlink control information are executable by the processor to cause the apparatus to:
transmit the downlink control information in a second time interval corresponding to an active mode of the first set of network operation modes for the first network entity, the second time interval overlapping with a third time interval corresponding to an inactive mode of the second set of network operation modes for the second network entity.

20. The apparatus of claim 18, wherein the downlink control information indicates a second control resource set index or a second set of virtual component carriers associated with the second network entity.

21. The apparatus of claim 18, wherein the downlink control information comprises multiple sets of parameters for communicating with multiple network entities during time intervals corresponding to flexible modes, the multiple sets of parameters comprising the one or more parameters for communicating with the second network entity during the first time interval.

22. The apparatus of claim 13, wherein the first network operation sequence is associated with a first set of parameters, and wherein the second network operation sequence is associated with a second set of parameters different from the first set of parameters, the first set of parameters, the second set of parameters, or both, comprising a network energy consumption level, a maximum data rate, or both.

23. The apparatus of claim 13, wherein the first control signaling is the same as the second control signaling.

24. The apparatus of claim 13, wherein the first set of network operation modes, the second set of network operation modes, or both, comprise a first network energy saving mode, a second network energy saving mode, a flexible mode, a legacy mode, an inactive mode, or any combination thereof.

25. A method for wireless communication at a user equipment (UE), comprising:
receiving first control signaling indicating a first network operation sequence associated with a first network entity, the first network operation sequence comprising a first set of time intervals corresponding to a first set of network operation modes for the first network entity;
receiving second control signaling indicating a second network operation sequence associated with a second network entity, the second network operation sequence different from the first network operation sequence, the second network operation sequence comprising a second set of time intervals corresponding to a second set of network operation modes for the second network entity, the second set of time intervals and the second set of network operation modes different from the first set of time intervals and the first set of network operation modes, respectively;
communicating with the first network entity in accordance with the first network operation sequence; and
communicating with the second network entity in accordance with the second network operation sequence.

26. The method of claim 25, wherein the first network entity is associated with a first control resource set index, and wherein communicating with the first network entity comprises:
communicating with the first network entity in accordance with the first network operation sequence and based at least in part on control information associated with the first control resource set index.

27. The method of claim 25, wherein the first network entity is associated with a first set of virtual component carriers, and wherein communicating with the first network entity comprises:
communicating with the first network entity on the first set of virtual component carriers in accordance with the first network operation sequence.

28. A method for wireless communication at a first network entity, comprising:
transmitting, to a user equipment (UE), first control signaling indicating a first network operation sequence associated with the first network entity, the first network operation sequence comprising a first set of time intervals corresponding to a first set of network operation modes for the first network entity;
transmitting, to the UE, second control signaling indicating a second network operation sequence associated with a second network entity, the second network operation sequence different from the first network operation sequence, the second network operation sequence comprising a second set of time intervals corresponding to a second set of network operation modes for the second network entity, the second set of time intervals and the second set of network operation modes different from the first set of time intervals and the first set of network operation modes, respectively; and
communicating with the UE in accordance with the first network operation sequence.

29. The method of claim 28, wherein the first network entity is associated with a first control resource set index, and wherein communicating with the UE comprises:
communicating with the UE in accordance with the first network operation sequence and based at least in part on control information associated with the first control resource set index.

30. The method of claim 28, wherein the first network entity is associated with a first set of virtual component carriers, and wherein communicating with the UE comprises:
communicating with the UE on the first set of virtual component carriers in accordance with the first network operation sequence.
